(19) United States
(12) Patent Application Publication
(10) Pub. No.: US 2007/0275269 A1
(43) Pub. Date: Nov. 29, 2007

(54) Magnetic recording medium and magnetic storage unit

(75) Inventors: Hideaki Takahoshi, Higashine (JP); Atsushi Endo, Higashine (JP); Reiko Murao, Higashine (JP); Shinya Sato, Higashine (JP); Akira Kikuchi, Higashine (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/583,283

(22) Filed: Oct. 19, 2006

(30) Foreign Application Priority Data
May 25, 2006 (JP) 2006-145672

(51) Int. Cl. G11B 5/66

(52) U.S. Cl. 428/828.1; 428/829; 428/830

(57) ABSTRACT

A magnetic recording medium is disclosed that includes a substrate; and an underlayer, a first magnetic layer, a non-magnetic coupling layer, a second magnetic layer, a third magnetic layer, a non-magnetic separation layer, and a fourth magnetic layer stacked in this order on the substrate. The first magnetic layer and the second magnetic layer are antiferromagnetically exchange-coupled, and the second magnetic layer and the third magnetic layer are ferromagnetically exchange-coupled. The third magnetic layer has an anisotropic magnetic field smaller than the anisotropic magnetic field of the second magnetic layer, and has a saturation magnetization greater than the saturation magnetization of the second magnetic layer.

### BACKGROUND OF THE INVENTION

1. Field of the Invention

The present invention relates generally to magnetic recording media and magnetic storage units suitable for high-density recording, and more particularly to a magnetic recording medium having a recording layer formed of multiple magnetic layers, and to a magnetic storage unit including the same.

2. Description of the Related Art

Magnetic recording media, whose recording densities have increased rapidly in these years, have an annual growth rate of 100%. The limit of surface recording density in longitudinal recording, which is a currently mainstream recording method, is expected to be 250 Gb/in². In magnetic recording media of longitudinal recording, an attempt is made to reduce medium noise in order to ensure signal-to-noise ratio (S/N ratio) in high-density recording. In order to reduce medium noise, magnetic particles forming magnetic regions are reduced in size, thereby reducing the zigzag of the boundary between magnetic regions, that is, a magnetic transition region. However, miniaturization of magnetic particles reduces their volumes, thus causing a residual magnetization thermal stability problem in that residual magnetization is reduced because of thermal fluctuation.

In order to achieve high-density recording, a magnetic recording medium having an object of reducing medium noise and ensuring the thermal stability of residual magnetization at the same time is proposed (see, for example, FIG. 7 of United States Patent Application Publication No. US 2002/0098390). According to a magnetic recording medium 100 shown in FIG. 1, a recording layer 101 has a structure in which an exchange coupling layer 102 formed by a first magnetic layer 103 and a second magnetic layer 105 antiferromagnetically exchange-coupled via a non-magnetic coupling layer 104; a spacer layer 106; and a third magnetic layer 108 are deposited in order on a substrate (not graphically illustrated). The magnetic recording medium 100 increases the thermal stability of residual magnetization by including the exchange coupling layer 102.

At the time of recording, information is recorded in the magnetic recording medium 100 shown in FIG. 1 by a recording magnetic field from a recording head (not graphically illustrated) positioned above the third magnetic layer 108 in the plane of the paper. The second magnetic layer 105 is remoter from the magnetic poles of the recording head than the third magnetic layer 108 is. Accordingly, the intensity of a recording magnetic field applied thereto is relatively low. Further, since the second magnetic layer 105 and the third magnetic layer 108 are not exchange-coupled, an exchange coupling magnetic field does not act on the second magnetic layer 105 from the third magnetic layer 108. This makes it difficult for the magnetization reversal of the second magnetic layer 105 to occur, thus causing a problem in that writing performance such as an overwrite characteristic is degraded. Degradation of the overwrite characteristic causes degradation of the SN ratio, thus making it difficult to achieve higher recording density.

On the other hand, it is possible to improve the overwrite characteristic by reducing the anisotropic magnetic field of the second magnetic layer 105. However, reduction in the anisotropic magnetic field reduces the thermal stability of residual magnetization.

### SUMMARY OF THE INVENTION

Embodiments of the present invention may solve or reduce one or more of the above problems.

According to one embodiment of the present invention, there are provided a magnetic recording medium in which the above-described problems are eliminated, and a magnetic storage unit including the same.

According to one embodiment of the present invention, there are provided a magnetic recording medium that has a good overwrite characteristic while ensuring the thermal stability of residual magnetization, and is capable of achieving high recording density, and a magnetic storage unit including the same.

According to one aspect of the present invention, there is provided a magnetic recording medium, including a substrate; and an underlayer, a first magnetic layer, a non-magnetic coupling layer, a second magnetic layer, a third magnetic layer, a non-magnetic separation layer, and a fourth magnetic layer stacked in order described on the substrate, wherein the first magnetic layer and the second magnetic layer are antiferromagnetically exchange-coupled, and the second magnetic layer and the third magnetic layer are ferromagnetically exchange-coupled; and the third magnetic layer has an anisotropic magnetic field smaller than an anisotropic magnetic field of the second magnetic layer, and has a saturation magnetization greater than a saturation magnetization of the second magnetic layer.

According to the above-described magnetic recording medium, the third magnetic layer having a smaller anisotropic magnetic field and a greater saturation magnetization than the second magnetic layer is provided on the recording element side (the side opposite to the substrate) of the second magnetic layer. Since the third magnetic layer has a smaller anisotropic magnetic field than the second magnetic layer, the magnetization of the third magnetic layer is reversed by a smaller recording magnetic field. As a result of the reversal of the magnetization of the third magnetic layer, an exchange coupling magnetic field is applied, parallel to the third magnetic layer, to the magnetization of the second magnetic layer, which is ferromagnetically exchange-coupled to the third magnetic layer. As a result, the recording magnetic field and additionally the exchange coupling magnetic field are applied to the second magnetic layer in the same direction, so that the magnetization of the second magnetic layer becomes easily-reversible. Accordingly, compared with the case without the third magnetic layer, writing performance such as an overwrite characteristic is improved according to this magnetic recording medium. Further, since the first magnetic layer antiferromagnetically exchange-coupled to the second magnetic layer is provided, the thermal stability of residual magnetization is ensured. Accordingly, this magnetic recording medium can enjoy high recording density.

According to another aspect of the present invention, there is provided a magnetic storage unit including the above-described magnetic recording medium and a recording and reproduction part configured to write information to and read information from the magnetic recording medium.

The above-described magnetic storage unit includes a magnetic recording medium that enjoys a good overwrite characteristic while ensuring the thermal stability of residual magnetization. Accordingly, the magnetic storage unit can achieve high density recording.

Thus, according to embodiments of the present invention, it is possible to provide a magnetic recording medium that enjoys a good overwrite characteristic while ensuring the thermal stability of residual magnetization, and can achieve high density recording, and to provide a magnetic storage unit having the same.

### BRIEF DESCRIPTION OF THE DRAWINGS

Other objects, features and advantages of the present invention will become more apparent from the following detailed description when read in conjunction with the accompanying drawings, in which:

FIG. 1 is a cross-sectional view of the recording layer of a conventional magnetic recording medium;

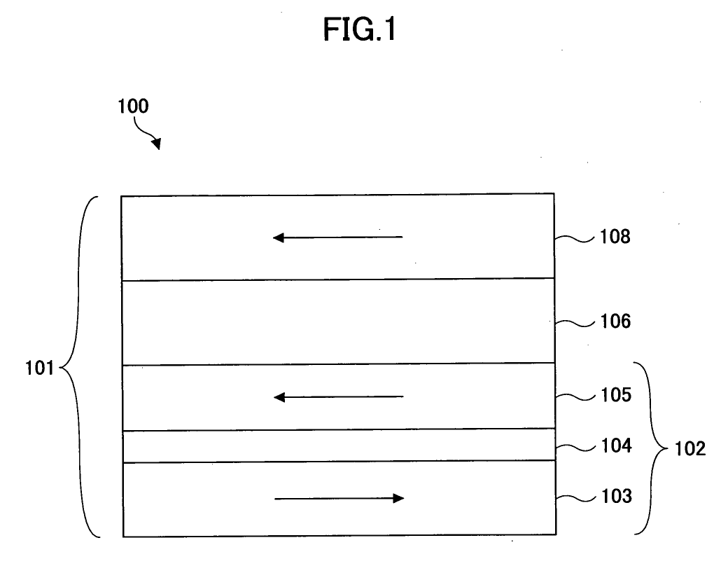

FIG. 2 is a cross-sectional view of a magnetic recording medium according to a first embodiment of the present invention;

FIG. 3 is a cross-sectional view of another magnetic recording medium according to the first embodiment of the present invention;

FIG. 4 is a characteristics table of the magnetic recording media of an example and a comparative example according to the first embodiment of the present invention;

FIG. 5 is a graph showing the relationship between the overwrite characteristic and tBr of each of the example and the comparative example according to the first embodiment of the present invention; and

FIG. 6 is a plan view of part of a magnetic storage unit according to a second embodiment of the present invention.

### DETAILED DESCRIPTION OF THE PREFERRED EMBODIMENTS

A description is given below, with reference to the accompanying drawings, of embodiments of the present invention.

### First Embodiment

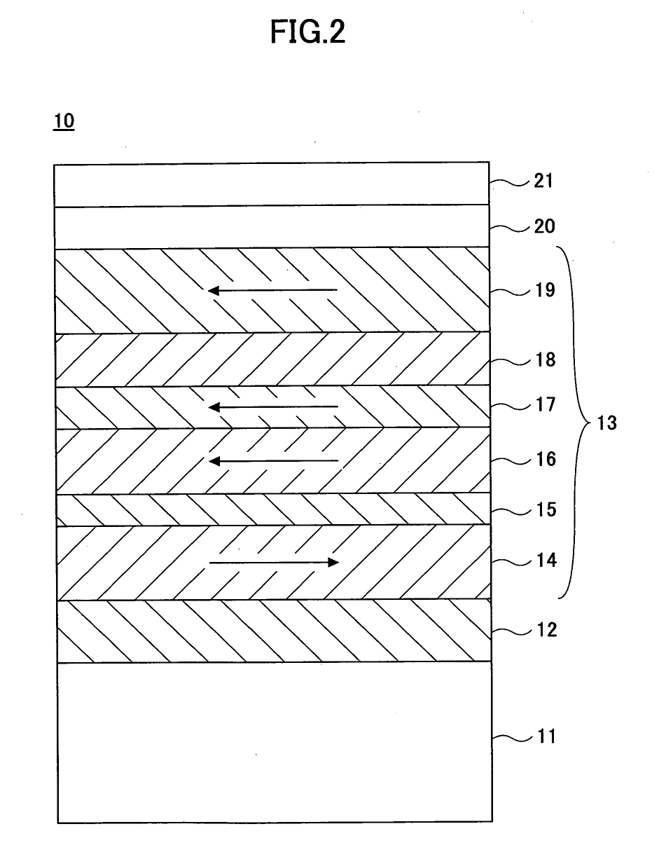

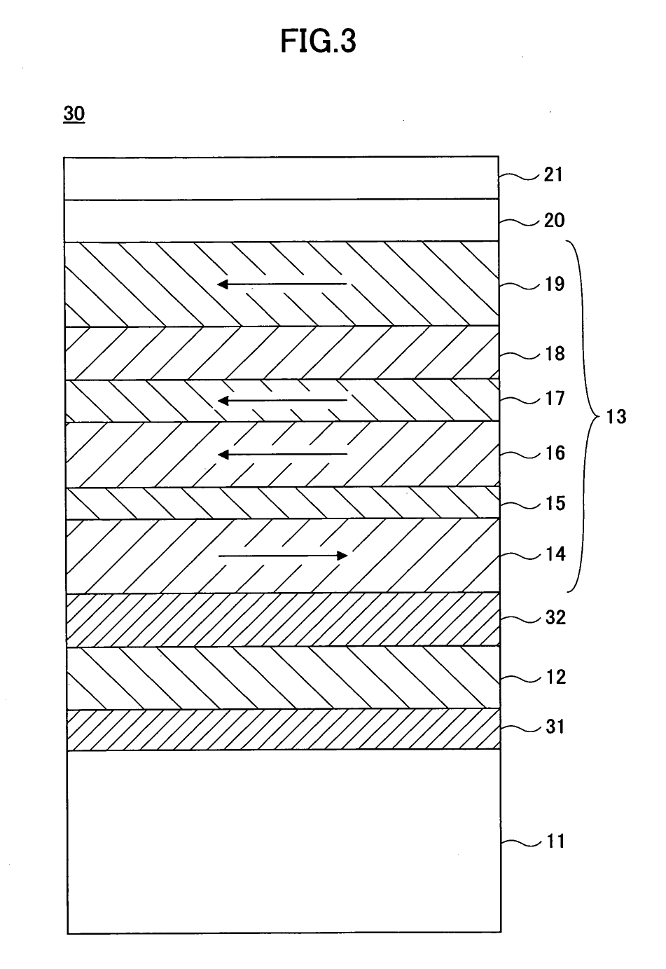

FIG. 2 is a cross-sectional view of a magnetic recording medium 10 according to a first embodiment of the present invention. In FIG. 2, each arrow indicates a direction of residual magnetization in the state where no external magnetic field is applied. The same applies to FIG. 3.

Referring to FIG. 2, the magnetic recording medium 10 of this embodiment includes a substrate 11, an underlayer 12, a recording layer 13, a protection film 20, and a lubricating layer 21. The underlayer 12, the recording layer 13, the protection film 20, and the lubricating layer 21 are stacked in order on the substrate 11. The recording layer 13 includes a first magnetic layer 14, a non-magnetic coupling layer 15, a second magnetic layer 16, a third magnetic layer 17, a non-magnetic separation layer 18, and a fourth magnetic layer 19, which are stacked in order from the underlayer 12 side.

The substrate 11 is not limited in particular. Substrates such as a glass substrate, a NiP-plated aluminum alloy substrate, a silicon substrate, a plastic substrate, a ceramic substrate, and a carbon substrate may be used as the substrate 11.

A texture formed of many grooves along a recording direction (corresponding to a circumferential direction if the magnetic recording medium 10 is a magnetic disk), such as a mechanical texture, may be formed on the surface of the substrate 11. Such a texture makes it possible to orient the crystals, particularly the c-axes (magnetocrystalline easy axes), of the magnetic layers 14, 16, 17, and 19 of the recording layer 13 in the recording direction. This improves the magnetic characteristics, and further, recording and reproduction characteristics such as reproduction output and resolution, of the magnetic recording medium 10.

The underlayer 12 is selected from Cr and Cr-M1 alloys having a body-centered cubic (bcc) crystal structure, where M1 is at least one selected from the group consisting of Mo, Mn, W, V, and B. By using the Cr-M1 alloy, the lattice matching of the underlayer 12 with the recording layer 13 thereon is improved, so that the crystallinity and the crystal orientation of each magnetic layer of the recording layer 13 can be improved. Further, the underlayer 12 may be multiple layers of Cr or the Cr-M1 alloy. This layer structure can prevent a crystal grain in the underlayer 12 from increasing in size, and further, can prevent the crystal grains of the recording layer 13 from increasing in size.

The film thickness of the underlayer 12 is not limited in particular. Preferably, however, the film thickness of the underlayer 12 is greater than or equal to 3 nm in terms of a sufficient improvement in the in-plane orientation of the magnetic layer 16, and is less than or equal to 30 nm in order to prevent the magnetic particles of the magnetic layer 16 from increasing excessively in size.

As described above, the recording layer 13 includes the first magnetic layer 14, the non-magnetic coupling layer 15, the second magnetic layer 16, the third magnetic layer 17, the non-magnetic separation layer 18, and the fourth magnetic layer 19, which are stacked in order from the underlayer 12 side. The first magnetic layer 14 and the second magnetic layer 16 are antiferromagnetically exchange-coupled via the non-magnetic coupling layer 15. That is, the magnetization of the first magnetic layer 14 and the magnetization of the second magnetic layer 16 are antiparallel to each other where no external magnetic field is applied. Further, the second magnetic layer 16 and the third magnetic layer 17 are ferromagnetically exchange-coupled. That is, the magnetization of the second magnetic layer 16 and the magnetization of the third magnetic layer 17 are parallel to each other where no external magnetic field is applied.

Each of the first through fourth magnetic layers 14, 16, 17, and 19 is formed of a ferromagnetic material selected from the group consisting of CoCr, CoPt, and CoCr—X1 alloys, where X1 is at least one selected from the group consisting of B, Cu, Mn, Mo, Nb, Pt, Ta, W, and Zr. The ferromagnetic material of each of the magnetic layers 14, 16, 17, and 19 has a hexagonal close-packed (hcp) crystal structure.

Preferably, the first magnetic layer 14 is formed of a ferromagnetic material selected from the group consisting of CoCr and CoCr—X2 alloys, where X2 is at least one selected from the group consisting of B, Cu, Mn, Mo, Nb, Pt, Ta, W, and Zr. If the first magnetic layer 14 thus does not contain Pt, its anisotropic magnetic field is relatively low. Accordingly, it is possible to avoid an adverse effect on the overwrite characteristic. Ferromagnetic materials suitable as the first magnetic layer 14 include CoCr, CoCrB, CoCrTa, CoCrMn, and CoCrZr.

Further, the film thickness of the first magnetic layer 14 is in the range of 0.5 nm to 20 nm. As described below, the first magnetic layer 14 is antiferromagnetically exchange-coupled to the second magnetic layer 16 so as to increase the thermal stability of the magnetization of magnetic regions corresponding to the bits of data recorded in the second magnetic layer 16 (and the third magnetic layer 17) (residual magnetization), thereby serving to increase long-term reliability as a recording medium.

The non-magnetic coupling layer 15 is selected from, for example, Ru, Rh, Ir, Ru-based alloys, Rh-based alloys, and Ir-based alloys. Preferably, the non-magnetic coupling layer 15 is Ru or a Ru-based alloy in terms of good lattice matching with the first magnetic layer 14 and the second magnetic layer 16 because Ru has an hcp crystal structure. Examples of the Ru-based alloy include Ru-M2, where M2 includes one selected from the group consisting of Co, Cr, Fe, Ni, and Mn. Further, the film thickness of the non-magnetic coupling layer 15 is in the range of 0.4 nm to 1.0 nm. By setting the film thickness of the non-magnetic coupling layer 15 in this range, the first magnetic layer 14 and the second magnetic layer 16 are antiferromagnetically exchange-coupled via the non-magnetic coupling layer 15.

Preferably, the second magnetic layer 16 is formed of a ferromagnetic material selected from the group consisting of CoPt, CoCrPt, and CoCrPt—X3 alloys, where X3 is at least one selected from the group consisting of B, Cu, Mo, Nb, Ta, W, and Zr. Ferromagnetic materials suitable as the second magnetic layer 16 include CoCrPt, CoCrPtB, CoCrPtTa, CoCrPtBCu, CoCrPtBTa, and CoCrPtBZr. The film thickness of the second magnetic layer 16 is in the range of 0.5 nm to 20 nm. The second magnetic layer 16 serves to store information by having magnetic regions corresponding to the bits of recorded data formed therein.

Preferably, the third magnetic layer 17 is formed of a ferromagnetic material selected from the group consisting of CoCr and CoCr—X1 alloys, where X1 is at least one selected from the group consisting of B, Cu, Mn, Mo, Nb, Pt, Ta, W, and Zr. Ferromagnetic materials suitable as the third magnetic layer 17 include CoCr, CoCrB, CoCrTa, CoCrPt, and CoCrPtB. Further, the film thickness of the third magnetic layer 17 is preferably in the range of 0.5 nm to 5 nm, and more preferably in the range of 1.0 nm to 2.0 nm. If the film thickness of the third magnetic layer 17 is less than 0.5 nm, the ratio of volume of the third magnetic layer 17 to the second magnetic layer 16 is too low. As a result, the overwrite characteristic improvement effect due to the low anisotropic magnetic field of the third magnetic layer 17 is not sufficiently produced. On the other hand, if the film thickness of the third magnetic layer 17 is greater than 5 nm, the ratio of volume of the third magnetic layer 17 to the second magnetic layer 16 is too high. As a result, the static coercive force of the recording layer 13 is reduced.

As described below, at the time of recording, the third magnetic layer 17 has its magnetization reversed by a recording magnetic field lower in intensity than the magnetization of the second magnetic layer 16 so as to apply to the second magnetic layer 16 an exchange coupling magnetic field that facilitates reversal of the magnetization of the second magnetic layer 16.

The material of the non-magnetic separation layer 18 is not limited in particular, but preferably, is a non-magnetic material selected from the group consisting of Ru, Cu, Cr, Rh, Ir, Ru-based alloys, Rh-based alloys, and Ir-based alloys in terms of good lattice matching with the third magnetic layer 17 and the fourth magnetic layer 19. Preferable Ru-based alloys include a non-magnetic material of Ru and at least one selected from the group consisting of Co, Cr, Fe, Ni, and Mn.

The non-magnetic separation layer 18 has such a film thickness as to prevent substantial exchange coupling of the third magnetic layer 17 and the fourth magnetic layer 19. Specifically, the film thickness of the non-magnetic separation layer 18 is in the range of 1.0 nm to 3 nm. If the film thickness of the non-magnetic separation layer 18 is less than 1.0 nm, antiferromagnetic exchange coupling is likely to act. If the film thickness of the non-magnetic separation layer 18 is greater than 3 nm, the third magnetic layer 17 is distant from a recording element so as to be less easily recordable. As a result, the overwrite characteristic is degraded. Further, the non-magnetic separation layer 18 stops the growth of the crystal grains of the second magnetic layer 16 and the third magnetic layer 17 so as to prevent the crystal grains from increasing in size, and avoids an increase in the width of the grain size distribution of the crystal grains. As a result, the SN ratio of the magnetic recording medium 10 is improved.

The fourth magnetic layer 19 is selected from the same ferromagnetic materials as for the second magnetic layer 16. Further, the film thickness of the fourth magnetic layer 19 is in the range of 0.5 nm to 20 nm. The fourth magnetic layer 19 serves to store information by having magnetic regions corresponding to the bits of recorded data formed therein.

A description is given below of the relationship among the layers of the recording layer 13. The anisotropic magnetic fields of the first through fourth magnetic layers 14, 16, 17, and 19 are Hk1, Hk2, Hk3, and Hk4, respectively. The saturation magnetizations of the first through fourth magnetic layers 14, 16, 17, and 19 are Ms1, Ms2, Ms3, and Ms4, respectively.

The third magnetic layer 17 has a smaller anisotropic magnetic field and a greater saturation magnetization than the second magnetic layer 16. That is, the ferromagnetic materials of the second magnetic layer 16 and the third magnetic layer 17 are determined so as to satisfy the following relationship:

Hk3<Hk2 and Ms3>Ms2. (1)

As a result, writing performance such as an overwrite characteristic is improved. The action of this is as follows.

The third magnetic layer 17 has a smaller anisotropic magnetic field than the second magnetic layer 16. Accordingly, at the time of recording, the magnetization of the third magnetic layer 17 is reversed by a recording magnetic field from a recording element, which is lower in intensity than the second magnetization layer 16, in the direction of the recording magnetic field. As a result of the reversal of the magnetization of the third magnetic layer 17, an exchange coupling magnetic field in the direction to reverse the magnetization of the second magnetic layer 16, as well as the recording magnetic field, is applied to the magnetization of the second magnetic layer 16. Accordingly, the magnetization of the second magnetic layer 16 is easily reversible. Further, since the third magnetic layer 17 has a greater saturation magnetization than the second magnetic layer 16 (Ms3>Ms2), the third magnetic layer 17 has large exchange coupling energy so that a large exchange coupling magnetic field acts on the second magnetic layer 16. As a result, the magnetization of the second magnetic layer becomes more easily reversible.

If the ferromagnetic materials of the second magnetic layer 16 and the third magnetic layer 17 are CoCrPt or CoCrPt—X3 alloys, it is preferable that the third magnetic layer 17 have a lower Pt content and a higher Co content than the second magnetic layer 16 if the content of each element is expressed in atomic concentration. This selection makes it possible to satisfy the above-described relationship of Hk3<Hk2 and Ms3>Ms2. The anisotropic magnetic field can be controlled by the Pt content. For example, it is possible to reduce the anisotropic magnetic field by reducing the Pt content. Further, the saturation magnetization can be controlled by the Co content. For example, it is possible to increase the saturation magnetization by increasing the Co content. The third magnetic layer 17 may be formed of a ferromagnetic material of a composition that does not include Pt.

Further, it is preferable, in that the overwrite characteristic is conspicuously improved, that the second magnetic layer 16 and the third magnetic layer 17 satisfy the relationship:

Hk3+2000 (Oe)<Hk2, (2)

and more preferably, the relationship:

Hk3+5000 (Oe)<Hk2, (3)

where Hk2 and Hk3 are in units of Oe.

Further, it is preferable, in that the anisotropic energy of the third magnetic layer 17 is sufficiently ensured, that the second magnetic layer 16 and the third magnetic layer 17 satisfy the relationship:

Ms3>Ms2+200 emu/cm³, (4)

where Ms3 and Ms2 are in units of emu/cm³. Further, it is preferable in particular that the second magnetic layer 16 and the third magnetic layer 17 satisfy the above-described anisotropic magnetic field relationship (2) or (3) and the above-described saturation magnetization relationship (4) at the same time.

In the second magnetic layer 16 and the third magnetic layer 17, the above-described preferable difference in the anisotropic magnetic field or the saturation magnetization is applied when the preferable difference can be ensured.

Further, preferably, the second magnetic layer 16 and the fourth magnetic layer 19 are formed of the same material. As described above, the second magnetic layer 16 and the fourth magnetic layer 19 have the function of recording each bit of recorded data. Therefore, by forming the second magnetic layer 16 and the fourth magnetic layer 19 of the same material, both magnetic layers 16 and 19 can have substantially the same magnetic characteristics and substantially the same magnetization transition width and bit length.

Further, the fourth magnetic layer 19 may be formed of a ferromagnetic material having a greater anisotropic magnetic field than that of the second magnetic layer 16. Since the fourth magnetic layer 19 is not exchange-coupled to another magnetic layer, it is possible to increase the thermal stability of its residual magnetization by forming the fourth magnetic layer 19 of a ferromagnetic material having a greater anisotropic magnetic field. The fourth magnetic layer 19 is closer to a recording element than the second magnetic layer 16 is. Accordingly, a recording magnetic field of greater intensity is applied to the fourth magnetic layer 19 than to the second magnetic layer 16. Accordingly, it is possible to prevent degradation of the overwrite characteristic.

Preferably, the first magnetic layer 14 and the second magnetic layer 16 satisfy the relationship Hk1≦Hk2. This is preferable in the following respect. As a result of forming the first magnetic layer 14 of a ferromagnetic material having an anisotropic magnetic field smaller than or equal to that of the second magnetic layer 16, the magnetization of the first magnetic layer 14 is easily reversible so as to ensure formation of a magnetization antiparallel to the magnetization of the second magnetic layer 16 in the condition where no external magnetic field is applied.

The anisotropic magnetic field is a physical property value characteristic of a ferromagnetic material. The anisotropic magnetic field can be measured with a torque magnetometer or a vibrating sample magnetometer that can detect magnetizations in two axial directions.

Letting the residual magnetizations of the first through fourth magnetic layers 14, 16, 17, and 19 be Br1, Br2, Br3, and Br4, respectively, and letting the film thicknesses of the first through fourth magnetic layers 14, 16, 17, and 19 be t1, t2, t3, and t4, respectively, the film thickness-residual flux density product of the recording layer 13 is expressed as Br4×t4+Br3×t3+Br2×t2−Br1×t1 from the above-described configuration of the recording layer 13 because the direction of the residual magnetization of the first magnetic layer 14 is opposite to the direction of the residual magnetizations of the other magnetic layers 16, 17, and 19 in the condition where no external magnetic field is applied. The reproduction output is proportional to the residual magnetization-film thickness product of the recording layer 13 in a region where the recording density is relatively low. Accordingly, by setting Br1 through Br4 and t1 through t4, the film thickness-residual flux density product of the recording layer 13 is determined so that a reproduction output suitable for a magnetic storage unit is obtained. Providing the first magnetic layer 14 in the recording layer 13 can increase the total film thickness of the first through fourth magnetic layers 14, 16, 17, and 19, so that it is possible to increase the thermal stability of the residual magnetization of the entire recording layer 13.

The protection film 20 is, for example, 0.5 nm through 15 nm in thickness, and is formed of a material selected from amorphous carbon, hydrogenated carbon, carbon nitride, and aluminum oxide. The material of the protection film 20 is not limited in particular.

The lubricating layer 21 is formed of, for example, a lubricant having a main chain of perfluoropolyether of 0.5 nm to 5 nm in film thickness. For example, hydroxyl-terminated or piperonyl-terminated perfluoropolyether may be employed as the lubricant. The lubricating layer 21 may be either provided or not provided depending on the material of the protection film 20.

Next, a description is given, with reference to FIG. 2, of a method of manufacturing the magnetic recording medium 10 according to the first embodiment.

First, after cleaning and drying the surface of the substrate 11, the substrate 11 is subjected to heat treatment. By the heat treatment, the substrate 11 is heated to a predetermined temperature, for example, 150° C., with a heater in a vacuum atmosphere. Before the heat treatment, texture processing may be performed on the surface of the substrate 11. The texture processing may be mechanical texture processing that forms multiple grooves on the surface of the substrate 11 along the circumferential direction thereof if the substrate 11 has a disk shape. By forming such a texture, it is possible to orient the c-axis of the recording layer 13 in the circumferential direction.

Next, the underlayer 12 and the layers 14 through 19 of the recording layer 13 are formed in order with a sputtering apparatus such as a DC (direct current) magnetron sputtering apparatus or an RF (AC) sputtering apparatus using their respective sputtering targets formed of the corresponding materials described above. Specifically, film formation is performed at a pressure of, for example, 0.67 Pa with a predetermined input power supply, using a sputtering apparatus in which film formation chambers for forming corresponding layers by DC magnetron sputtering are successively disposed and feeding Ar gas into the film formation chambers. Preferably, the sputtering apparatus is evacuated to 10⁻⁷ Pa in advance before film formation, and thereafter, an atmospheric gas such as Ar gas is fed.

Next, the protection film 20 is formed on the recording layer 13 using sputtering, CVD (Chemical Vapor Deposition), or FCA (Filtered Cathodic Arc). Between the process of forming the underlayer 12 and the process of forming the protection film 20, it is preferable to maintain a vacuum or inert gas atmosphere between processes. This makes it possible to retain the cleanness of the surface of each formed layer.

Next, the lubricating layer 21 is formed on the surface of the protection film 20. A dilution formed by diluting a lubricant with a solvent is applied using dipping or spin coating, so that the lubricating layer 21 is formed. Thereby, the magnetic recording medium 10 according to this embodiment is formed.

As described above, in the magnetic recording medium 10, the third magnetic layer 17 having a smaller anisotropic magnetic field and a greater saturation magnetization than the second magnetic layer 16 is provided on the recording element side (the side opposite to the substrate 11) of the second magnetic layer 16 forming the recording layer 13. Since the third magnetic layer 17 has a smaller anisotropic magnetic field than the second magnetic layer 16, the magnetization of the third magnetic layer 17 is reversed by a recording magnetic field smaller than a recording magnetic field that independently reverses the magnetization of the second magnetic layer 16. As a result of the reversal of the magnetization of the third magnetic layer 17, an exchange coupling magnetic field is applied, parallel to the third magnetic layer 17, to the magnetization of the second magnetic layer 16, which is ferromagnetically exchange-coupled to the third magnetic layer 17. As a result, the recording magnetic field and additionally the exchange coupling magnetic field are applied to the second magnetic layer 16 in the same direction, so that the magnetization of the second magnetic layer 16 becomes easily reversible. Accordingly, compared with the case without the third magnetic layer 17, writing performance such as an overwrite characteristic is improved. At the same time, the second magnetic layer 16 and the first magnetic layer 14 antiferromagnetically exchange-coupled thereto are provided, so that the thermal stability of residual magnetization is ensured. Accordingly, the magnetic recording medium 10 of this embodiment can enjoy high recording density.

FIG. 3 is a cross-sectional view of another magnetic recording medium 30 according to the first embodiment. In FIG. 3, the same elements as those described above are referred to by the same reference numerals, and a description thereof is omitted.

Referring to FIG. 3, the magnetic recording medium 30 includes the substrate 11, and has a seed layer 31, the underlayer 12, a non-magnetic intermediate layer 32, the recording layer 13, the protection film 20, and the lubricating layer 21 stacked in order on the substrate 11.

The seed layer 31 is formed of an amorphous non-magnetic alloy material. Preferably, the seed layer 31 is selected from CoW, CrTi, NiP, and ternary or higher order alloys employing CoW, CrTi, or NiP as their principal components because these alloys are particularly excellent in reducing the grain size of the crystal grains of the underlayer 12. Further, preferably, the film thickness of the seed layer 31 is in the range of 5 nm to 100 nm. Since the seed layer 31 is amorphous, the surface of the seed layer 31 is crystallographically uniform. Therefore, compared with the case of forming the underlayer 12 directly on the surface of the substrate 11, it is possible to avoid providing the underlayer 12 with crystallographic anisotropy. Accordingly, the underlayer 12 is likely to form its own crystal structure, so that crystallinity and crystal orientation are improved. Further, the crystallinity and the crystal orientation of the non-magnetic intermediate layer 32 and the recording layer 13 that epitaxially grow on the underlayer 12 are improved. As a result, the c-axis in-plane orientation and the in-plane coercive force of the magnetic particles of each of the magnetic layers 14, 16, 17, and 19 of the recording layer 13 (hereinafter, simply referred to as “recording layer 13” unless otherwise noted) are improved, so that the recording and reproduction characteristics are improved.

Further, since the seed layer 31 is amorphous, it is possible to miniaturize the crystal grains and to narrow the grain size dispersion of the crystal grains of the underlayer 12. This reduces the grain size and narrows the grain size dispersion of the recording layer 13 through the non-magnetic intermediate layer 32, thereby improving the SN ratio. Further, a texture may be formed on the surface of the seed layer 31 along the circumferential direction. In this case, the texture on the surface of the substrate 11 may be omitted.

The non-magnetic intermediate layer 32 is formed of a Co-M3 alloy having an hcp crystal structure, where M3 is one selected from the group consisting of Cr, Ta, Mo, Mn, Re, and Ru. The non-magnetic intermediate layer 32 further improves the c-axis in-plane orientation of the recording layer 13. That is, the non-magnetic intermediate layer 32 synergistically increases the in-plane orientation improvement effect of the underlayer 12 so as to further improve the c-axis in-plane orientation of the recording layer 13.

Further, in the case of forming a texture on the substrate 11 or the seed layer 31, the effect of the texture and the effect of the underlayer 12 and the non-magnetic intermediate layer 32 are combined, so that the recording layer 13 has an extremely good c-axis orientation in the direction in which the texture is formed, that is, in the recording direction. Preferably, the film thickness of the non-magnetic intermediate layer 32 is 0.5 nm to 10 nm.

As described above, according to the magnetic recording medium 30, the seed layer 31 and the non-magnetic intermediate layer 32 increase the c-axis in-plane orientation and the in-plane coercive force of the recording layer 13, and at the same time, reduce the grain size and narrow the grain size dispersion of the recording layer 13, thereby improving the SN ratio.

### EXAMPLE

Magnetic recording media of an example according to the first embodiment of the present invention and magnetic recording media of a comparative example that is not according to the present invention were made.

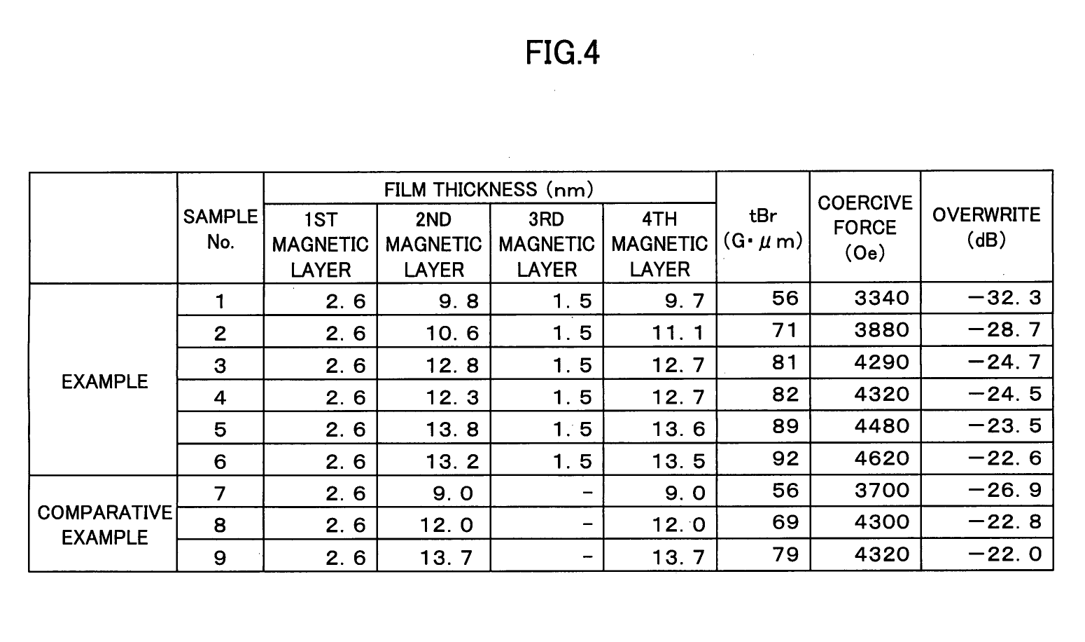

FIG. 4 is a characteristics table of the magnetic recording media of the example and the comparative example. FIG. 4 shows the overwrite characteristic of a recording layer, the film thickness of each magnetic layer of the recording layer, and the film thickness-residual flux density product tBr and the coercive force of the entire recording layer.

The magnetic recording media of the example were made as follows. First, a texture was formed on the surface of a disk-shaped glass substrate in a circumferential direction thereof. Further, after cleaning and drying the glass substrate, each layer of the magnetic recording media was formed using a DC magnetron sputtering apparatus as follows. The glass substrate was heated to 200° C. in a vacuum. Thereafter, in an argon gas atmosphere, a Cr alloy film (7 nm) serving as an underlayer, a CoCr film serving as the first magnetic layer of a recording layer, a Ru film (0.7 nm) serving as the non-magnetic coupling layer of the recording layer, a CoCrPt₁₃B film serving as the second magnetic layer of the recording layer, a CoCrPt₅B film serving as the third magnetic layer of the recording layer, a Ru film (1.3 nm) serving as the non-magnetic separation layer of the recording layer, a CoCrPt₁₃B film serving as the fourth magnetic layer of the recording layer, and a carbon film (4 nm) serving as a protection film were formed in this order. Further, a lubricating layer (1.5 nm) of perfluoropolyether was formed on the surface of the protection film by dipping. Thereby, the magnetic recording media of the example were made. The second magnetic layer and the fourth magnetic layer were equal in composition. The above parenthesized numerical values indicate film thickness. The numerical values in the above compositions indicate Pt content in atomic concentration (%).

The anisotropic magnetic fields (Oe) and the saturation magnetizations (emu/cm³) of the first through fourth magnetic layers are as follows:

First magnetic layer: 50 Oe, 600 emu/cm³;

Second magnetic layer: 9400 Oe, 260 emu/cm³;

Third magnetic layer: 4400 Oe, 480 emu/cm³; and

Fourth magnetic layer: 9400 Oe, 260 emu/cm³.

The anisotropic magnetic fields (Oe) and the saturation magnetizations (emu/cm³) of the first through fourth magnetic layers were obtained as follows. Samples were formed under the same conditions as the magnetic recording media of the example by having each of the first through fourth magnetic layers independently deposited in a single layer on the underlayer. Their anisotropic magnetic fields were measured with a torque magnetometer, and their saturation magnetizations were measured with a vibrating sample magnetometer.

As shown in FIG. 4, the film thickness-residual flux density product tBr is different in Samples No. 1 through No. 6 of the example. Specifically, Samples No. 1 through No. 6 are different in one or both of the thicknesses of the CoCrPt₁₃B films of the second and fourth magnetic layers.

On the other hand, the magnetic recording media of the comparative example were made in the same manner as those of the example except that the CoCrPt₅B film was not formed as the third magnetic layer. The film thickness-residual flux density product tBr is different in Samples No. 7 through No. 9 of the comparative example. Specifically, Samples No. 7 through No. 9 are different in the thicknesses of the second and fourth magnetic layers.

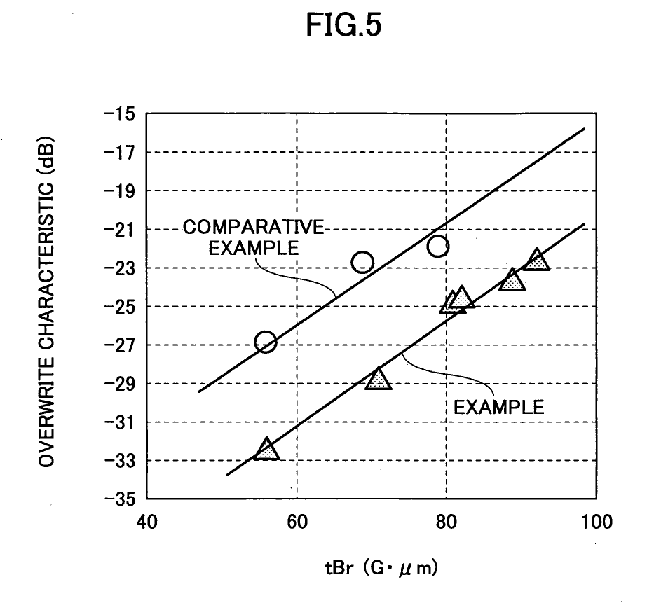

FIG. 5 is a graph showing the relationship between the overwrite characteristic and tBr of each of the example and the comparative example shown in FIG. 4.

FIGS. 4 and 5 show that the overwrite characteristic of the example is better than that of the comparative example by approximately 5 dB with the same film thickness-residual flux density product tBr. This shows that the overwrite characteristic can be significantly improved by providing the third magnetic layer between the second magnetic layer and the non-magnetic separation layer.

The film thickness-residual flux density product tBr is a required characteristic in the case of mounting a magnetic recording medium in a magnetic storage unit. Therefore, it is extremely effective to compare overwrite characteristics based on the film thickness-residual flux density product tBr. The overwrite characteristics were obtained by performing measurement with a composite magnetic head (having a recording element and a reproduction element) using a commercial spin stand. First, recording and reproduction were performed with a linear recording density of 90 kFCI, and further recording was performed with a linear recording density of 360 kFCI. Then the residual level of the first recorded 90 kFCI signal was measured, thereby obtaining the overwrite characteristic.

### Second Embodiment

A description is given of a magnetic storage unit including a magnetic recording medium according to a second embodiment of the present invention.

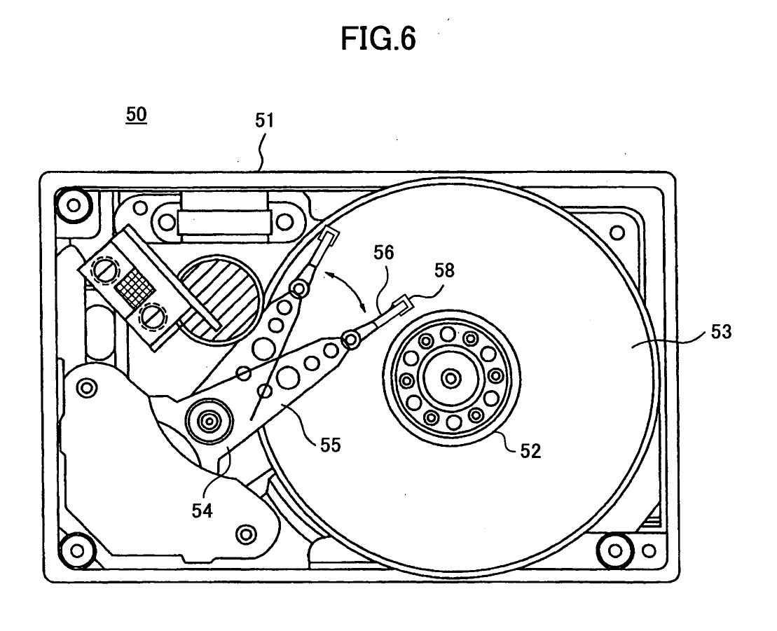

FIG. 6 is a diagram showing part of a magnetic storage unit 50 according to the second embodiment. Referring to FIG. 6, the magnetic storage unit 50 includes a housing 51. In the housing 51, the magnetic storage unit 50 further includes a hub 52 rotated by a spindle (not graphically illustrated), a magnetic recording medium 53 rotatably fixed to the hub 52, an actuator unit 54, an arm 55 and a suspension 56 attached to the actuator unit 54 and movable in the radial directions of the magnetic recording medium 53, and a magnetic head 58 supported by the suspension 56. The magnetic head 58 is a composite type, including a recording head of an MR element (magnetoresistive element), a GMR element (giant magnetoresistive element), or a TMR element (tunnel magnetoresistive element) and an induction-type recording head.

The basic configuration of the magnetic storage unit 50 is known, and accordingly, a detailed description thereof is omitted.

The magnetic recording medium 53 may be the magnetic recording medium 10 or 30 according to the first embodiment. The magnetic recording medium 53 is excellent in writing performance such as an overwrite characteristic. Accordingly, the magnetic storage unit 50 can achieve high recording density.

The basic configuration of the magnetic storage unit 50 is not limited to the one shown in FIG. 6. The magnetic storage unit 50 may have two or more magnetic recording media. Further, the magnetic head 58 is not limited to the above-described configuration, and a known magnetic head may be employed as the magnetic head 58.

Thus, according to one aspect of the present invention, there is provided a magnetic recording medium, including a substrate; and an underlayer, a first magnetic layer, a non-magnetic coupling layer, a second magnetic layer, a third magnetic layer, a non-magnetic separation layer, and a fourth magnetic layer stacked in order described on the substrate, wherein the first magnetic layer and the second magnetic layer are antiferromagnetically exchange-coupled, and the second magnetic layer and the third magnetic layer are ferromagnetically exchange-coupled; and the third magnetic layer has an anisotropic magnetic field smaller than the anisotropic magnetic field of the second magnetic layer, and has a saturation magnetization greater than the saturation magnetization of the second magnetic layer.

According to another aspect of the present invention, there is provided a magnetic storage unit including the above-described magnetic recording medium and a recording and reproduction part configured to write information to and read information from the magnetic recording medium.

The present invention is not limited to the specifically disclosed embodiments, and variations and modifications may be made without departing from the scope of the present invention.

For example, in the above description of the second embodiment, a magnetic disk is taken as an example of the magnetic recording medium. However, the magnetic recording medium may be a magnetic tape. In place of a disk-shaped substrate, the magnetic tape employs a tape-shaped substrate such as a tape-shaped plastic film of PET, PEN or polyimide.

The present application is based on Japanese Priority Patent Application No. 2006-145672, filed on May 25, 2006, the entire contents of which are hereby incorporated by reference.

What is claimed is:

1. A magnetic recording medium, comprising:
a substrate; and an underlayer, a first magnetic layer, a non-magnetic coupling layer, a second magnetic layer, a third magnetic layer, a non-magnetic separation layer, and a fourth magnetic layer stacked in order described on the substrate,
wherein the first magnetic layer and the second magnetic layer are antiferromagnetically exchange-coupled, and the second magnetic layer and the third magnetic layer are ferromagnetically exchange-coupled; and
the third magnetic layer has an anisotropic magnetic field smaller than an anisotropic magnetic field of the second magnetic layer, and has a saturation magnetization greater than a saturation magnetization of the second magnetic layer.

2. The magnetic recording medium as claimed in claim 1, wherein the fourth magnetic layer has an anisotropic magnetic field greater than or equal to the anisotropic magnetic field of the second magnetic layer.

3. The magnetic recording medium as claimed in claim 1, wherein the second magnetic layer and the third magnetic layer satisfy a relationship of Hk3+2000 (Oe)≦Hk2, where Hk2 is the anisotropic magnetic field of the second magnetic layer and Hk3 is the anisotropic magnetic field of the third magnetic layer.

4. The magnetic recording medium as claimed in claim 1, wherein the second magnetic layer and the third magnetic layer satisfy a relationship of Ms3>Ms2+200 (emu/cm³), where Ms2 is the saturation magnetization of the second magnetic layer and Ms3 is the saturation magnetization of the third magnetic layer.

5. The magnetic recording medium as claimed in claim 1, wherein each of the first through fourth magnetic layers is formed of a ferromagnetic material selected from the group consisting of CoCr, CoPt, and CoCr—X1 alloys, where X1 is at least one selected from the group consisting of B, Cu, Mn, Mo, Nb, Pt, Ta, W, and Zr.

6. The magnetic recording medium as claimed in claim 1, wherein each of the second magnetic layer and the fourth magnetic layer is formed of a ferromagnetic material selected from the group consisting of CoPt, CoCrPt, and CoCrPt—X3 alloys, where X3 is at least one selected from the group consisting of B, Mo, Nb, Ta, W, Zr, and Cu.

7. The magnetic recording medium as claimed in claim 1, wherein the second magnetic layer and the fourth magnetic layer are formed of ferromagnetic materials having a same composition.

8. The magnetic recording medium as claimed in claim 1, wherein the third magnetic layer is formed of a ferromagnetic material selected from the group consisting of CoCr and CoCr—X1 alloys, where X1 is at least one selected from the group consisting of B, Mo, Mn, Nb, Ta, W, Cu, Zr, and Pt.

9. The magnetic recording medium as claimed in claim 1, wherein a film thickness of the third magnetic layer is in a range of 0.5 nm to 5 nm.

10. The magnetic recording medium as claimed in claim 1, wherein the second magnetic layer and the third magnetic layer are formed of one of CoCrPt and a CoCrPt—X3 alloy, where X3 is at least one selected from the group consisting of B, Mo, Nb, Ta, W, and Cu; and
the third magnetic layer has a lower Pt content and a higher Co content in atomic concentration than the second magnetic layer.

11. The magnetic recording medium as claimed in claim 1, wherein the non-magnetic coupling layer is formed of a material selected from the group consisting of Ru, Rh, Ir, Ru-based alloys, Rh-based alloys, and Ir-based alloys; and a film thickness of the non-magnetic coupling layer is in a range of 0.4 nm to 1.0 nm.

12. The magnetic recording medium as claimed in claim 1, wherein the non-magnetic separation layer is formed of a non-magnetic alloy, and a film thickness of the non-magnetic separation layer is in a range of 1.0 nm to 3 nm.

13. The magnetic recording medium as claimed in claim 1, wherein the underlayer is selected from Cr and Cr-M1 alloys having a body-centered cubic crystal structure, where M1 is at least one selected from the group consisting of Mo, Mn, W, V, and B.

14. The magnetic recording medium as claimed in claim 1, further comprising:
a seed layer-between the substrate and the underlayer,
wherein the seed layer is formed of an amorphous non-magnetic alloy material.

15. The magnetic recording medium as claimed in claim 1, further comprising:
a non-magnetic intermediate layer between the underlayer and the first magnetic layer,
wherein the non-magnetic intermediate layer is formed of a Co-M3 alloy having a hexagonal close-packed crystal structure, where M3 is at least one selected from the group consisting of Cr, Ta, Mo, Mn, Re, and Ru.

16. A magnetic storage unit, comprising:
the magnetic recording medium as set forth in claim 1; and
a recording and reproduction part configured to write information to and read information from the magnetic recording medium.
